(19) United States
(12) Patent Application Publication
(10) Pub. No.: US 2009/0279499 A1
(43) Pub. Date: Nov. 12, 2009

(54) Wireless resource allocating apparatus, on-vehicle apparatus, and wireless resource allocating system

(75) Inventor: Mamoru Machida, Kawasaki (JP)

Correspondence Address: HANIFY & KING PROFESSIONAL CORPORATION, 1055 Thomas Jefferson Street, NW, Suite 400, WASHINGTON, DC, 20007, US

(73) Assignee: FUJITSU LIMITED

(21) Appl. No.: 12/320,246

(22) Filed: Jan. 22, 2009

(30) Foreign Application Priority Data
May 7, 2008 (JP) 2008-121626

(51) Int. Cl. H04W 72/04; H04J 3/00

(52) U.S. Cl. 370/330; 370/337; 370/329

(57) ABSTRACT

A wireless resource allocating apparatus includes a ranging signal receiving unit that receives a signal indicating that an on-vehicle apparatus loaded on a vehicle is present within a predetermined area, an on-vehicle apparatus quantity calculating unit that calculates the number of on-vehicle apparatuses present within the area from the signal received by the ranging signal receiving unit, a wireless resource allocating unit that allocates wireless resources to be used for inter-vehicle communication among a plurality of on-vehicle apparatuses present within the area and non-inter-vehicle communication between the on-vehicle apparatuses and a communicating apparatus other than the on-vehicle apparatuses based on the number of on-vehicle apparatuses calculated by the on-vehicle apparatus quantity calculating unit, and an allocation instruction transmitting unit that instructs an on-vehicle apparatus present within the area to use the wireless resources allocated by the wireless resource allocating unit.

### CROSS-REFERENCE TO RELATED APPLICATION(S)

This application is based upon and claims the benefit of priority of the prior Japanese Patent Application No. 2008-121626, filed on May 7, 2008, the entire contents of which are incorporated herein by reference.

### FIELD

The embodiment(s) discussed herein is (are) directed to a wireless resource allocating apparatus, an on-vehicle apparatus, a wireless resource allocating system, and a wireless resource allocating method.

### BACKGROUND

Conventionally, an ITS (Intelligent Transport System) has been known that integrates roads and vehicles as one system to realize services that aim at improvement of safety, improvement of transportation efficiency, and improvement of amenity. In this system, by a multiple accessing scheme such as an OFDMA (Orthogonal Frequency Division Multiple Access) and a TDMA (Time Division Multiple Access), coexistence is about to be realized of: road-vehicle communication executed between a wireless base station apparatus (for example, a roadside apparatus) that governs vehicles and roads, and an on-vehicle apparatus loaded on a vehicle; and inter-vehicle communication executed among a plurality of on-vehicle apparatuses.

An example of a system that has such road-vehicle communication and inter-vehicle communication coexisting with each other can be a disclosed technique of allocating a frequency that is different from the frequency that a wireless base station apparatus uses to inter-vehicle communication in an area that allows road-vehicle communication (Japanese Patent Application Laid-open No. 2000-201103). Road-vehicle communication through which a wireless base station apparatus receives traffic congestion information from a vehicle that encounters traffic congestion and through which the apparatus transmits the traffic congestion information to other vehicles running after the vehicle, and inter-vehicle communication through which a vehicle having received traffic congestion information transmits the traffic congestion information to other vehicles running after the vehicle are disclosed (Japanese Patent Application Laid-open No. 2006-259861).

However, in a conventional system that has such road-vehicle communication and inter-vehicle communication coexisting with each other, a problem has arisen that the efficiency of use of wireless resources such as frequencies and time periods allocated to each of the road-vehicle communication and the inter-vehicle communication is low in an area that allows the road-vehicle communication.

That is, for example, in the case where the wireless resources are allocated to the road-vehicle communication and the inter-vehicle communication by the OFDMA, when the wireless resources allocated are not used, those wireless resources not used are wasted and, therefore, efficiency of the use of the wireless resources allocated is lowered.

As the above Japanese Patent Application Laid-open No. 2000-201103 describes, in the case where different frequencies are allocated respectively to the road-vehicle communication and the inter-vehicle communication, when a time period during which the allocated frequency is not used becomes long even for at least one of those types of communication, the allocation of the frequency during the time period during which the frequency is not used is wasted and the efficiency of use of the frequency allocated is lowered.

In the above Japanese Patent Application Laid-open No. 2006-259861, similarly, in the case where the road-vehicle communication and the inter-vehicle communication are caused to coexist and the wireless resources are allocated to both of them, when the resources allocated are not used, the resources not used are wasted and the efficiency of use of the wireless resources allocated is lowered.

### SUMMARY

According to an aspect of an embodiment, a wireless resource allocating apparatus includes a receiving unit that receives a signal that indicates that an on-vehicle apparatus loaded on a vehicle is present within a predetermined area; a calculating unit that calculates the number of the on-vehicle apparatuses present within the predetermined area from the signal received by the receiving unit; an allocating unit that allocates wireless resources to be used for inter-vehicle communication between the on-vehicle apparatuses present within the predetermined area and non-inter-vehicle communication between the on-vehicle apparatus and a communicating apparatus other than the on-vehicle apparatus based on the number of the on-vehicle apparatuses calculated by the calculating unit; and an instructing unit that instructs the on-vehicle apparatus present within the predetermined area to use the wireless resources allocated by the allocating unit.

According to another aspect of an embodiment, an on-vehicle apparatus includes a receiving unit that receives an instruction of allocation of wireless resources to be used for execution of inter-vehicle communication between on-vehicle apparatuses each loaded on a vehicle present within a predetermined area and non-inter-vehicle communication between the on-vehicle apparatuses and a communicating apparatus other than the on-vehicle apparatuses; and a communicating unit that, according to the instruction received by the receiving unit, executes the inter-vehicle communication using the wireless resources allocated to the inter-vehicle communication and that executes the non-inter-vehicle communication using the wireless resources allocated to the non-inter-vehicle communication.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWING(S)

FIG. 1 is a diagram of the overview of a wireless resource allocating system according to an embodiment;

FIG. 2 is a functional block diagram of the configuration of a wireless resource allocating apparatus according to the embodiment;

FIG. 3 is a diagram of an example of the data structure of a road-vehicle and inter-vehicle allocation table according to the embodiment;

FIG. 4 is a functional block diagram of the configuration of an on-vehicle apparatus according to the embodiment;

FIG. 5 is a diagram of an example of the frame configuration representing allocation of the wireless resources;

FIG. 6 is a diagram of an example of the road-vehicle and inter-vehicle frame (time division) configuration;

FIG. 7 is a diagram of an example of the road-vehicle and inter-vehicle frame (frame allocation) configuration;

FIG. 8 is a diagram of an example of the road-vehicle and inter-vehicle frame (time, division and frequency division) configuration;

FIG. 9 is a sequence diagram of the overview of processes of the wireless resource allocating system according to the embodiment; and

FIG. 10 is a sequence diagram of the overview of other processes of the wireless resource allocating system according to the embodiment.

### DETAILED DESCRIPTION OF EMBODIMENT(S)

An embodiment of a wireless resource allocating apparatus, an on-vehicle apparatus, a wireless resource allocating system, and a wireless resource allocating method will be described in detail referring to the accompanying drawings. The present invention is not limited by the embodiment.

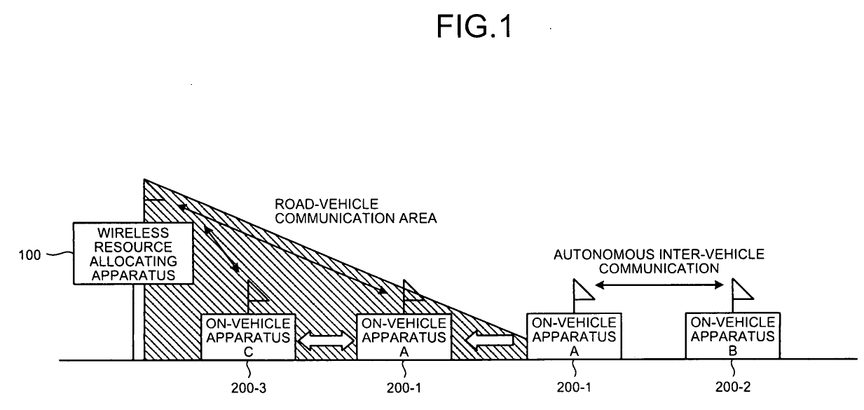

FIG. 1 is a diagram of the overview of a wireless resource allocating system according to the embodiment. As depicted in FIG. 1, in the wireless resource allocating system, a wireless resource allocating apparatus 100 allocates wireless resources that are used for road-vehicle communication with an on-vehicle apparatus A200-1 in an area that allows the communication and inter-vehicle communication between the on-vehicle apparatus A200-1 and another on-vehicle apparatus C200-3. However, the road-vehicle communication may also be communication between the on-vehicle apparatus A200-1 and a communicating apparatus other than the wireless resource allocating apparatus 100.

The on-vehicle apparatus A200-1 in the wireless resource allocating system communicates with the wireless resource allocating apparatus 100 and the on-vehicle apparatus C200-3 in the area within which the wireless resource allocating apparatus 100 can communicate, using the wireless resources allocated by the wireless resource allocating apparatus 100. The area within which the wireless resource allocating apparatus 100 is able to communicate is, for example, within an area of several ten meters in the DSRC communication scheme and, in the embodiment, the area within which an apparatus is able to communicate is referred to as “road-vehicle communication area”.

The wireless resource allocating apparatus 100 is disposed on a road and allocates wireless resources that are used for the road-vehicle communication with on-vehicle apparatuses present in the road-vehicle communication area and the inter-vehicle communication among the on-vehicle apparatuses present in the road-vehicle communication area, based on the number of the on-vehicle apparatuses present in the road-vehicle communication area. More specifically, when the on-vehicle apparatus A200-1 enters the road-vehicle communication area, the wireless resource allocating apparatus 100 receives a signal that indicates that the on-vehicle apparatus A200-1 is present in the road-vehicle communication area. The wireless resource allocating apparatus 100 judges the number of on-vehicle apparatuses present in the current road-vehicle communication area from the received signal, the wireless resource allocating apparatus 100 determines allocations of the wireless resources to be used for road-vehicle communication and inter-vehicle communication in the area based on the judged number of the on-vehicle apparatuses, and the apparatus 100 allocates the wireless resources according to the determined allocations. In this case, the wireless resource allocating apparatus 100 allocates the wireless resources by distributing a plurality of time slots in a frame representing a communication unit time period according to the determined allocations to the road-vehicle communication and the inter-vehicle communication. The wireless resource allocating apparatus 100 transmits information on the allocated wireless resources to the on-vehicle apparatus A200-1 in the road-vehicle communication area. Hereinafter, all time slots distributed to the road-vehicle communication in the frame are collectively referred to as “road-vehicle region” and all time slots distributed to the inter-vehicle communication is collectively referred to as “inter-vehicle region”.

The on-vehicle apparatus A200-1 is loaded on a vehicle and, outside the road-vehicle communication area, the apparatus A200-1 executes autonomous inter-vehicle communication that are independent from other communication with an on-vehicle apparatus B200-2 present outside the road-vehicle communication area. Inside the road-vehicle communication area, the on-vehicle apparatus A200-1: stops the autonomous inter-vehicle communication; receives the information on the allocated wireless resources; judges the road-vehicle region and the inter-vehicle region from the allocated wireless resources; executes the road-vehicle communication using the road-vehicle region; and executes the inter-vehicle communication using the inter-vehicle region.

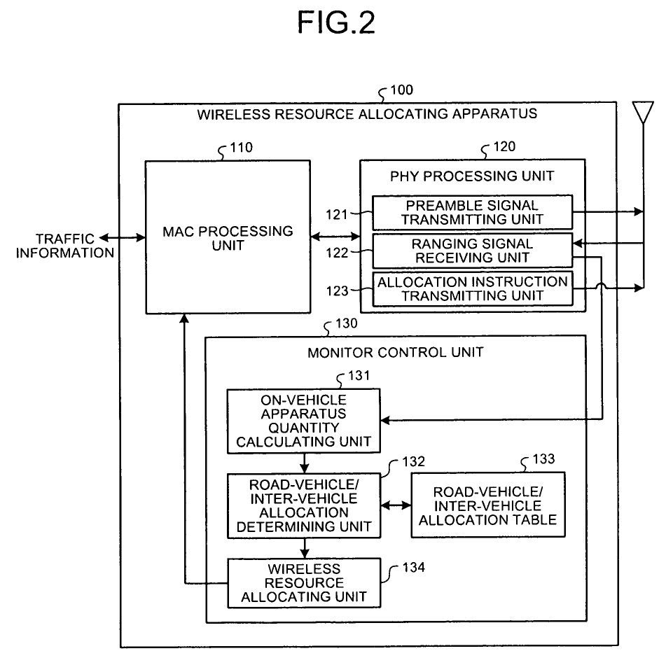

FIG. 2 is a functional block diagram of the configuration of the wireless resource allocating apparatus 100 according to the embodiment. As depicted in FIG. 2, the wireless resource allocating apparatus 100 includes an MAC processing unit 110, a PHY processing unit 120, and a monitor control unit 130. Though either of the OFDMA scheme and the TDMA scheme may be employed for the communication system, the case where the OFDMA scheme is employed will be described in the embodiment.

The MAC processing unit 110 has an MAC (Media Access Control) layer function of executing encoding and error correction of communication data such as, for example, road information received from a sensor external to the wireless resource allocating apparatus 100.

The PHY processing unit 120 is a processing unit that determines a physical connection and transmission schemes to communicate with the on-vehicle apparatuses and the PHY processing unit 120 has a transmission function and a reception function. The PHY processing unit 120 includes, as processing units corresponding to the transmission function, a preamble signal transmitting unit 121 and an allocation instruction transmitting unit 123 and, as a processing unit corresponding to the reception function, a ranging signal receiving unit 122.

The preamble signal transmitting unit 121 transmits a preamble signal by superposing the signal on a frame to start communication with an on-vehicle apparatus that is approaching the road-vehicle communication area. A preamble signal is always superposed at the head of communication data defined by the OFDMA scheme.

The allocation instruction transmitting unit 123 transmits to an on-vehicle apparatus an instruction of allocation of the wireless resources to be used when the road-vehicle communication and the inter-vehicle communication are executed in the road-vehicle communication area. Details of the allocation of the wireless resources to be used for the road-vehicle communication and the inter-vehicle communication will be described later.

The ranging signal receiving unit 122 receives from an on-vehicle apparatus a ranging signal that notifies that the on-vehicle apparatus is present in the road-vehicle communication area and the ranging signal receiving unit 122 notifies an on-vehicle apparatus quantity calculating unit 131 of the reception of the ranging signal.

The monitor control unit 130 monitors and controls various processes that are executed in the configuration of the wireless resource allocating apparatus 100. The monitor control unit 130 includes as processing units that closely concern the embodiment the on-vehicle apparatus quantity calculating unit 131, a road-vehicle/inter-vehicle allocation determining unit 132, a road-vehicle/inter-vehicle allocation table 133, and a wireless resources allocating unit 134.

The on-vehicle apparatus quantity calculating unit 131 calculates the number of on-vehicle apparatuses currently present within the road-vehicle communication area using the notice by the ranging signal receiving unit 122. For example, the on-vehicle apparatus quantity calculating unit 131 determines the number of the on-vehicle apparatuses present within the road-vehicle communication area by summing up the number of notices from the ranging signal receiving unit 122 received within a predetermined time period until the present. The on-vehicle apparatus quantity calculating unit 131 may determine the number of responses to inquiry information regularly transmitted from the PHY processing unit 120 as the number of the on-vehicle apparatuses present within the road-vehicle communication area to check whether the on-vehicle apparatuses that have been allocated with the wireless resources in the past are also currently present in the road-vehicle communication area. However, when the ranging signals received by the ranging signal receiving unit 122 are transmitted from one same on-vehicle apparatus, the on-vehicle apparatus quantity calculating unit 131 does not sum up these signals doubly.

The road-vehicle/inter-vehicle allocation determining unit 132 determines the allocation of the wireless resources to execute the road-vehicle communication with the on-vehicle apparatuses present within the road-vehicle communication area and the inter-vehicle communication among the on-vehicle apparatuses present within the road-vehicle communication area from the number of the on-vehicle apparatuses calculated by the on-vehicle apparatus quantity calculating unit 131. More specifically, the road-vehicle/inter-vehicle allocation determining unit 132 retrieves the allocation of the wireless resources for the road-vehicle communication and the inter-vehicle communication from the road-vehicle/inter-vehicle allocation table 133 using the number of the on-vehicle apparatuses calculated by the on-vehicle apparatus quantity calculating unit 131 as a key.

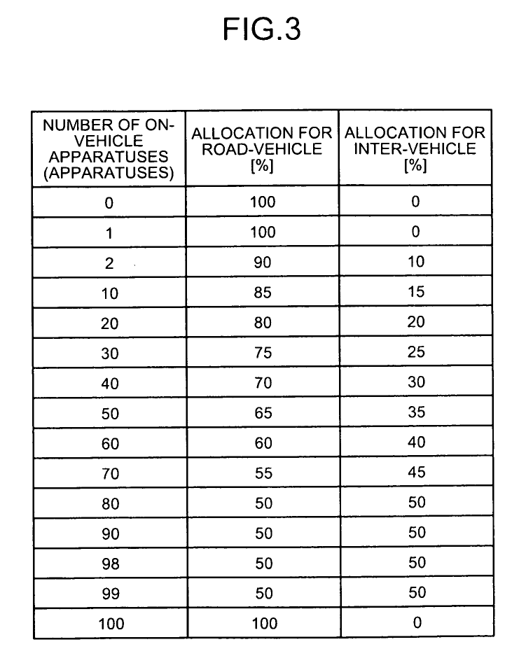

The road-vehicle/inter-vehicle allocation table 133 retains the ratios of the wireless resources to be allocated to the road-vehicle communication and the inter-vehicle communication correlating the ratios with the number of on-vehicle apparatuses present within the road-vehicle communication area. The data structure of the road-vehicle/inter-vehicle allocation table 133 according to the embodiment will be described referring to FIG. 3. As depicted in FIG. 3, the road-vehicle/inter-vehicle allocation table 133 retains the number of on-vehicle apparatuses (apparatuses), the road-vehicle allocation representing the allocation of the wireless resources to be used for the road-vehicle communication (%), and the inter-vehicle allocation representing the allocation of the wireless resources to be used for the inter-vehicle communication (%). An example of the road-vehicle allocation and the inter-vehicle allocation of the wireless resources will be depicted.

The road-vehicle/inter-vehicle allocation table 133 retains the allocation such that the road-vehicle allocation is 100% and the inter-vehicle allocation is 0% when the number of on-vehicle apparatuses present within the road-vehicle communication area is zero or one. Therefore, when the number of on-vehicle apparatuses present within the road-vehicle communication area is zero or one, no wireless resource is allocated to the inter-vehicle communication, and allocation of the wireless resources to be wasted is reduced.

The inter-vehicle allocation in the case where the number of on-vehicle apparatuses present within the road-vehicle communication area is two or more and 99 or fewer increases from 10% to 50% as the number of on-vehicle apparatuses increases. The road-vehicle allocation in this case decreases from 90% to 50% as the number of on-vehicle apparatuses increases. The road-vehicle allocation in the case where the number of on-vehicle apparatuses present within the road-vehicle communication area is 100 or more that indicates the saturated state is 100% and the inter-vehicle allocation in this case is 0%. This is because congestion occurs in the road-vehicle communication area when the number of on-vehicle apparatuses present within the road-vehicle communication area is saturated. That is, within the road-vehicle communication area, the on-vehicle apparatuses are not movable and the need for the inter-vehicle communication is weak and, therefore, the wireless resource allocating apparatus 100 is able to reduce the allocation of the wireless resources to be wasted by allocating all the wireless resources to the road-vehicle communication. The allocation for the road-vehicle communication and the allocation for the inter-vehicle communication of the wireless resources being correlated with the number of on-vehicle apparatuses are not limited to the above figures. The road-vehicle/inter-vehicle allocation table 133 may retain the absolute amounts of the wireless resources instead of the ratios, such as the road-vehicle allocation, the inter-vehicle allocation, and actual allocation.

Returning to FIG. 2, the wireless resources allocating unit 134 allocates the wireless resources to be used for the road-vehicle communication and the inter-vehicle communication by applying to them the allocation of the wireless resources to be used for the road-vehicle communication and the inter-vehicle communication determined by the road-vehicle/inter-vehicle allocation determining unit 132. More specifically, the wireless resource allocating unit 134 distributes the time slots in the frame according to the allocation of the wireless resources to be used for the road-vehicle communication and the inter-vehicle communication determined by the road-vehicle/inter-vehicle allocation determining unit 132 and, thereby, the wireless resource allocating unit 134 allocates the wireless resources to be used for the road-vehicle communication and the inter-vehicle communication. The wireless resource allocating unit 134 may allocate the wireless resources to be used for the road-vehicle communication and the inter-vehicle communication by distributing a plurality of frames in frames according to the allocation of the wireless resources to be used for the road-vehicle communication and the inter-vehicle communication. The wireless resource allocating unit 134 may allocate the wireless resources to be used for the road-vehicle communication and the inter-vehicle communication by dividing the frequency band that is useable within the road-vehicle communication area according to the allocation of the wireless resources to be used for the road-vehicle communication and the inter-vehicle communication.

Thereby, the wireless resource allocating apparatus 100 reduces the allocation of the wireless resources for the inter-vehicle communication when the number of on-vehicle apparatuses present within the road-vehicle communication area is small, and the wireless resource allocating apparatus 100 increases the allocation of the wireless resources for the inter-vehicle communication when the number of on-vehicle apparatuses is large. Thereby, the wireless resource allocating apparatus 100 is able to cause the inter-vehicle communication and the road-vehicle communication to be executed according to the number of on-vehicle apparatuses and the wireless resource allocating apparatus 100 is able to increase the efficiency of use of the wireless resources to be used for the inter-vehicle communication and the road-vehicle communication. The wireless resource allocating apparatus 100 allocates the wireless resources to be used for the inter-vehicle communication and the road-vehicle communication within the road-vehicle communication area and, thereby, the inter-vehicle communication and the road-vehicle communication are executed each using different wireless resources within the road-vehicle communication area and, therefore, interference between the inter-vehicle communication and the road-vehicle communication is able to be prevented.

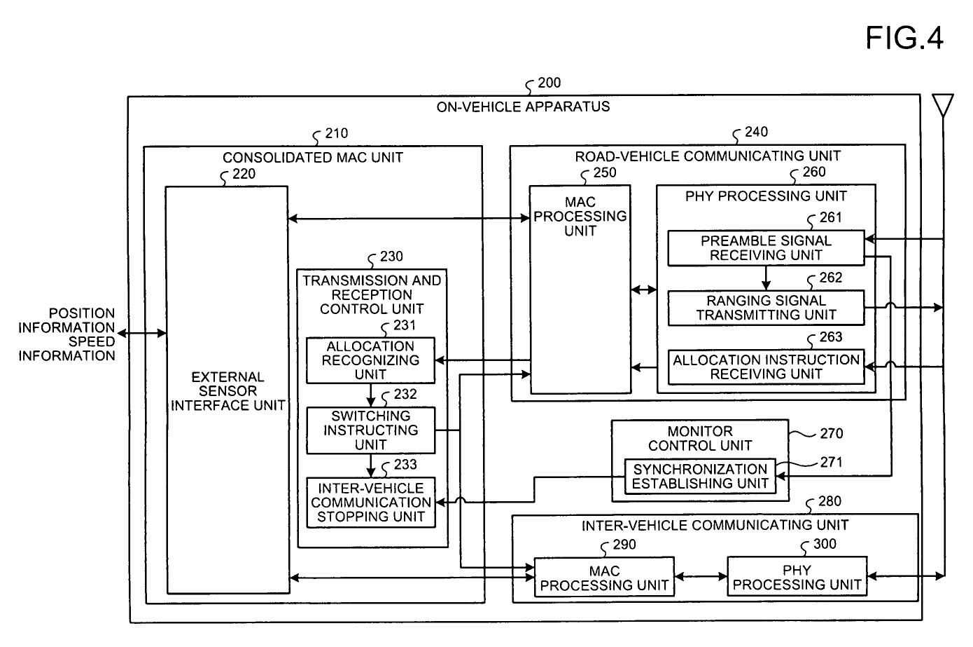

FIG. 4 is a functional block diagram of the configuration of an on-vehicle apparatus according to the embodiment. As depicted in FIG. 4, an on-vehicle apparatus 200 includes: a consolidated MAC unit 210 that includes an external sensor interface unit 220 and a transmission and reception control unit 230; a road-vehicle communicating unit 240 that includes an MAC processing unit 250 and a PHY processing unit 260; a monitor control unit 270 that includes a synchronization establishing unit 271; and an inter-vehicle communicating unit 280 that includes an MAC processing unit 290 and a PHY processing unit 300. In this case, the on-vehicle apparatus 200 executes the inter-vehicle communication and the road-vehicle communication according to the instruction of the allocation of the wireless resources to be used for executing the road-vehicle communication and the inter-vehicle communication within the road-vehicle communication area transmitted from the wireless resource allocating apparatus 100. Therefore, the on-vehicle apparatus 200 executes the inter-vehicle communication and stops the road-vehicle communication when the wireless resources are in the inter-vehicle region, and executes the road-vehicle communication and stops the inter-vehicle communication when the wireless resources are in the road-vehicle region.

The external sensor interface unit 220 receives, for example, speed information, and vehicle information from the exterior of the on-vehicle apparatus and the external sensor interface unit 220 notifies the MAC processing unit 250 of the road-vehicle communicating unit 240 or the MAC processing unit 290 of the inter-vehicle communicating unit 280 of these pieces of information. When the external sensor interface unit 220 is notified of the information that is transmitted from the wireless resource allocating apparatus 100 and other on-vehicle apparatuses, from the MAC processing units (250 and 290), the external sensor interface unit 220 transmits the information to exterior of the on-vehicle apparatus.

The transmission and reception control unit 230 includes an allocation recognizing unit 231, a switching instructing unit 232, and an inter-vehicle communication stopping unit 233. The allocation recognizing unit 231 obtains from the MAC processing unit 250 the allocation instruction of the wireless resources to be used for the road-vehicle communication and the inter-vehicle communication within the road-vehicle communication area and the allocation recognizing unit 231 recognizes the allocation of the wireless resources to be used for the road-vehicle communication and the inter-vehicle communication within the road-vehicle communication area. That is, the allocation recognizing unit 231 recognizes the road-vehicle region to be used for the road-vehicle communication and the inter-vehicle region to be used for the inter-vehicle communication based on the instruction of the allocation of the wireless resources to be used for the road-vehicle communication and the inter-vehicle communication.

The switching instructing unit 232 switches between the road-vehicle communication and the inter-vehicle communication according to the road-vehicle region and the inter-vehicle region of the wireless resources recognized by the allocation recognizing unit 231. More specifically, for example, the switching instructing unit 232 notifies the MAC processing unit 290 of the inter-vehicle communicating unit 280 of the stop of the transmission to the on-vehicle apparatus when a starting timing of the road-vehicle region arrives, and the switching instructing unit 232 notifies the MAC processing unit 250 of the road-vehicle communicating unit 240 of the cancellation of the stop of the transmission to the wireless resource allocating apparatus 100. Thereby, the on-vehicle apparatus 200 is able to execute the road-vehicle communication in the road-vehicle region to which the wireless resources are allocated. On the other hand, the switching instructing unit 232 notifies the MAC processing unit 250 of the road-vehicle communicating unit 240 of the stop of the transmission to the wireless resources allocating apparatus 100 when a starting timing of the inter-vehicle region arrives, and the switching instructing unit 232 notifies the MAC processing unit 290 of the inter-vehicle communicating unit 280 of the cancellation of the stop of the transmission to the on-vehicle apparatus. Thereby, the on-vehicle apparatus 200 is able to execute the inter-vehicle communication in the inter-vehicle region to which the wireless resources are allocated.

When the switching instructing unit 232 obtains an instruction instructing to stop the inter-vehicle communication from the inter-vehicle communication stopping unit 233, the switching instructing unit 232 notifies the MAC processing unit 290 of the inter-vehicle communicating unit 280 of the stop of the transmission to the on-vehicle apparatus.

When the inter-vehicle communication stopping unit 233 obtains an instruction instructing to stop the inter-vehicle communication from the synchronization establishing unit 271, the inter-vehicle communication stopping unit 233 instructs the switching instructing unit 232 to stop inter-vehicle communication.

The MAC processing unit 250 of the road-vehicle communicating unit 240 has the MAC layer function of executing encoding, error correction, etc., of road-vehicle communication data.

The PHY processing unit 260 of the road-vehicle communicating unit 240 is a processing unit that determines a physical connection and transmission schemes to communicate with the wireless resource allocating apparatus 100 and the PHY processing unit 260 has a transmission function and a reception function.

The PHY processing unit 260 of the road-vehicle communicating unit 240 includes, as processing units corresponding to the reception function, a preamble signal receiving unit 261 and an allocation instruction receiving unit 263 and, as a processing unit corresponding to the transmitting function, a ranging signal transmitting unit 262.

The preamble signal receiving unit 261 receives the preamble signal superposed at the head of the frame transmitted from the wireless resources allocating apparatus 100 when the on-vehicle apparatus 200 enters the road-vehicle communication area. The preamble signal receiving unit 261 notifies the ranging signal transmitting unit 262 of the reception of the preamble signal.

The allocation instruction receiving unit 263 receives an instruction of the allocation of the wireless resources to be used for execution of the road-vehicle communication and the inter-vehicle communication within the road-vehicle communication area transmitted from the wireless resource allocating apparatus 100.

The ranging signal transmitting unit 262 transmits to the wireless resource allocating apparatus 100 a ranging signal that notifies that the on-vehicle apparatus 200 is present within the road-vehicle communication area when the ranging signal transmitting unit 262 is notified from the preamble signal receiving unit 261 of the reception of the preamble signal.

The monitor control unit 270 monitors and controls various processes that are executed in the on-vehicle apparatus 200. The monitor control unit 270 includes the synchronization establishing unit 271 as a processing unit that closely concerns the embodiment. The synchronization establishing unit 271 establishes synchronization with the wireless resource allocating apparatus 100 using the preamble signal received by the preamble signal receiving unit 261. In this case, the synchronization establishing unit 271 instructs the inter-vehicle communication stopping unit 233 to stop the inter-vehicle communication. That is, the synchronization establishing unit 271 instructs the inter-vehicle communication stopping unit 233 to stop the inter-vehicle communication executed outside the road-vehicle communication area, for the on-vehicle apparatus 200 that is approaching the road-vehicle communication area to execute the road-vehicle communication and the inter-vehicle communication according to the allocation of the wireless resources instructed from the wireless resource allocating apparatus 100.

The MAC processing unit 290 of the inter-vehicle communicating unit 280 has the MAC layer function of executing encoding, error correction, etc., of the inter-vehicle communication data.

The PHY processing unit 300 of the inter-vehicle communicating unit 280 is a processing unit that determines the physical connection and transmission schemes to communicate with other on-vehicle apparatuses, and the PHY processing unit 300 has a transmission function and a reception function.

In this manner, when the on-vehicle apparatus 200 receives the instruction of the allocation of the wireless resources to be used for execution of the inter-vehicle communication and the road-vehicle communication to be used within the road-vehicle communication area, the on-vehicle apparatus 200 executes the inter-vehicle communication and the road-vehicle communication according to the wireless resources received. Thereby, no interference occurs between the inter-vehicle communication and the road-vehicle communication and, therefore, normal information is able to be received.

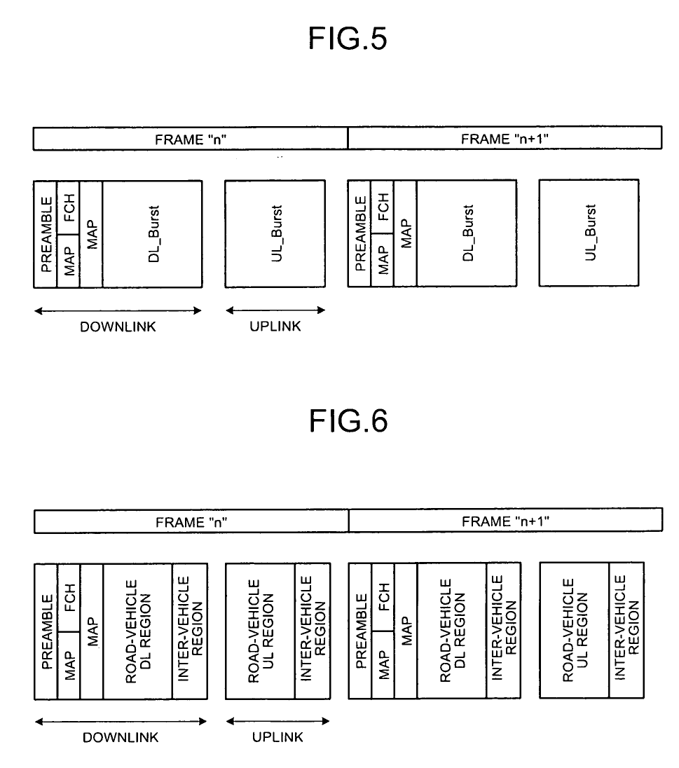

An example of the ordinary allocation of the wireless resource will be described referring to FIG. 5. FIG. 5 is a diagram of an example of the frame configuration representing the allocation of the wireless resources. As depicted in FIG. 5, a frame is configured by dividing the frame into a plurality of time slots. One frame includes a preamble, an FCH, uplink and downlink line allocation information (MAP), a downlink burst (DL_Burst) including transmission data for the downlink line, and an uplink burst (UL_Burst) including transmission data for the uplink line. The uplink and downlink line allocation information (MAP) includes uplink line allocation information and downlink line allocation information. The uplink line allocation information is an index of the uplink burst (UL_Burst) and indicates the starting timing of the uplink burst to be transmitted from the on-vehicle apparatus 200 to the wireless resource allocating apparatus 100. The downlink line allocation information is an index of the downlink burst (DL_Burst) and indicates the starting timing of the downlink burst to be transmitted from the wireless resource allocating apparatus 100 to the on-vehicle apparatus 200.

However, in the case where such fixed allocation of the wireless resources is employed, when the allocated time slots are not used, the wireless resources not used are wasted and the efficiency of use of the wireless resources allocated is lowered.

Therefore, in the embodiment, the wireless resources to be used for the inter-vehicle communication and the road-vehicle communication are variably allocated. Allocation of the wireless resources to be used for the road-vehicle communication and the inter-vehicle communication according to the embodiment will be described referring to FIGS. 6 to 8.

FIG. 6 is a diagram of the frame configuration that allocates a plurality of time slots in one same frame by dividing them into those for the road-vehicle communication and the inter-vehicle communication. One frame includes the preamble, an FCH, uplink and downlink line allocation information (MAP), a down burst (road-vehicle DL region) including transmission data of the downlink line of the road-vehicle communication, a down burst (inter-vehicle region) including transmission data of the inter-vehicle communication, an up burst (road-vehicle UL region) including transmission data of the uplink line of the road-vehicle communication, and an up burst (inter-vehicle region) including transmission data of the inter-vehicle communication. The uplink and downlink line allocation information (MAP) is indexes of the downlink burst (road-vehicle DL region and inter-vehicle region) and the uplink burst (road-vehicle UL region and inter-vehicle region) and the information indicates the starting position of each of the downlink bursts and each of the uplink bursts.

The allocation of the road-vehicle region (the road-vehicle DL region and the road-vehicle UL region) to be used for the road-vehicle communication and the inter-vehicle region to be used for the inter-vehicle communication in one frame is executed by the wireless resource allocating apparatus 100 based on the number of on-vehicle apparatuses present within the road-vehicle communication area. For example, the inter-vehicle region and the road-vehicle region are allocated based on the allocation of the inter-vehicle region and the road-vehicle region determined by the number of on-vehicle apparatuses present within the road-vehicle communication. The inter-vehicle region is further divided and is allocated to each inter-vehicle communication among the on-vehicle apparatuses. The wireless resource allocating apparatus 100 may execute the above division and allocation or the on-vehicle apparatus may execute it.

In this manner, the wireless resource allocating apparatus 100 allocates the time slots in the frame to the inter-vehicle communication and the road-vehicle communication and, thereby, the inter-vehicle communication and the road-vehicle communication each use the same frequency during a different time period. Therefore, no interference occurs between the wireless signals of those types of communication and, therefore, a receiving on-vehicle apparatus is able to receive the normal information.

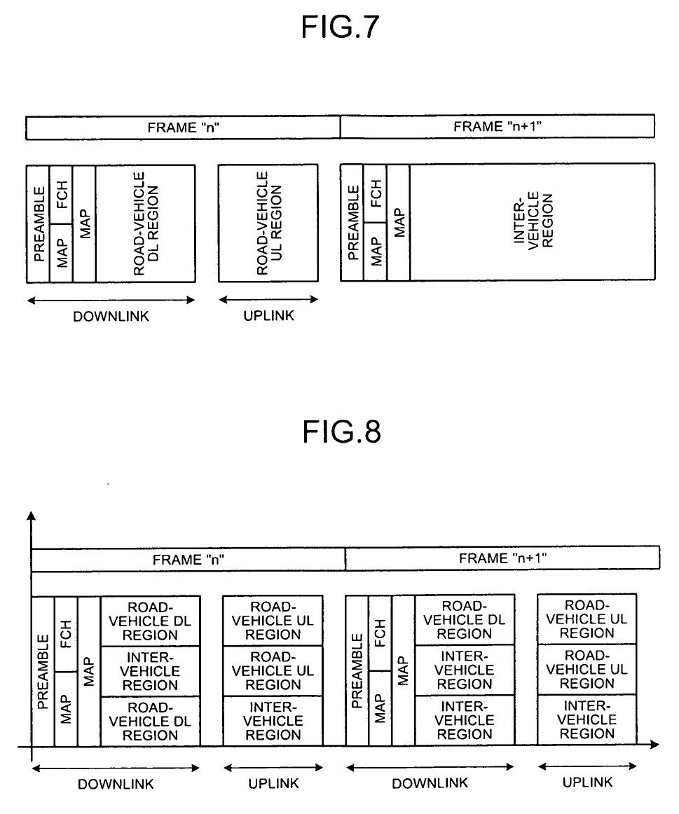

FIG. 7 is a diagram of the frame configuration that allocates a plurality of frames to the road-vehicle communication and the inter-vehicle communication by distributing those frames in frames. That is, the frames allocated to the road-vehicle communication are different from the frames allocated to the inter-vehicle communication.

One frame (frame “n” in FIG. 7) has the frame configuration to execute the road-vehicle communication, and includes the preamble, an FCH, uplink and downlink line allocation information (MAP), a down burst (road-vehicle DL region) including transmission data of the downlink line of the road-vehicle communication, and an up burst (road-vehicle UL region) including transmission data of the uplink line of the road-vehicle communication. The uplink and downlink line allocation information (MAP) is indexes of the downlink burst (road-vehicle DL region) and the uplink burst (road-vehicle UL region) and the information indicates the starting position of each of the downlink burst and the uplink burst.

The next frame (frame “n+1” in FIG. 7) has the frame configuration to execute the inter-vehicle communication, and includes the preamble, an FCH, uplink and downlink line allocation information (MAP), and a inter-vehicle region including transmission data of the inter-vehicle communication. The uplink and downlink line allocation information (MAP) is an index of the inter-vehicle communication and the information indicates the starting position of the inter-vehicle region. The inter-vehicle region is further divided and allocated to each inter-vehicle communication between the on-vehicle apparatuses. The wireless resource allocating apparatus 100 may execute the above division and allocation or the on-vehicle apparatus may do this.

The wireless resource allocating apparatus 100 executes the distribution of frames to execute the road-vehicle communication and the frames to execute the inter-vehicle communication based on the number of on-vehicle apparatuses present within the road-vehicle communication area. For example, the numbers of frames are allocated based on the number of on-vehicle apparatuses present within the road-vehicle communication area. It is assumed that which one of the road-vehicle communication and the inter-vehicle communication one frame is allocated to is distinguishable according to the index of the frame included in the uplink and downlink line allocation information (MAP) of the frame.

In this manner, the wireless resource allocating apparatus 100 distributes the plurality of frames in frames to the road-vehicle communication and the inter-vehicle communication in frames and, thereby, the road-vehicle communication and the inter-vehicle communication each use the frames in a different time period. Therefore, no interference occurs between the wireless signals of those types of communication and, therefore, a receiving on-vehicle apparatus is able to receive the normal information.

FIG. 8 is a diagram of the frame configuration that allocates a plurality of time slots in one same frame to the road-vehicle communication and the inter-vehicle communication and that allocates frequencies in a frequency. band usable within the road-vehicle communication area by dividing the frequencies. As depicted in FIG. 8, the frame is configured to allocate the frequency band usable within the road-vehicle communication to combinations of the road-vehicle communication and the inter-vehicle communication by dividing the band and is further configured to allocate the plurality of time slots to the road-vehicle communication and the inter-vehicle communication in each combination by distributing the slots. In this case, a combination refers to, for example, a combination of the road-vehicle DL region and the road-vehicle UL region, a combination of the inter-vehicle region and the road-vehicle UL region, a combination of the road-vehicle DL region and the inter-vehicle region, and a combination of the inter-vehicle region and the inter-vehicle region. However the combinations are not limited to the above.

The allocation of the plurality of time slots executed to the road-vehicle communication and the inter-vehicle communication in each combination is executed by the wireless resource allocating apparatus 100 based on the number of the on-vehicle apparatuses present within the road-vehicle communication area. For example, the inter-vehicle region and the road-vehicle region are allocated based on the allocation of the inter-vehicle region and the road-vehicle region determined according to the number of the on-vehicle apparatuses present within the road-vehicle communication area. The wireless resource allocating apparatus 100 executes the division of the frequency band useable within the road-vehicle communication area to each combination and this division may be executed based on the number of on-vehicle apparatuses present within the road-vehicle communication area or may be evenly dividing.

In this manner, the wireless resource allocating apparatus 100 allocates the plurality of time slots in the same frame to the road-vehicle communication and the inter-vehicle communication and allocates the frequencies of the frequency band usable within the road-vehicle communication area to the road-vehicle communication and the inter-vehicle communication by dividing the band. Thereby, the inter-vehicle communication and the road-vehicle communication each use different wireless resources. Therefore, no interference occurs between the wireless signals of those types of communication and, therefore, a receiving on-vehicle apparatus is able to receive the normal information.

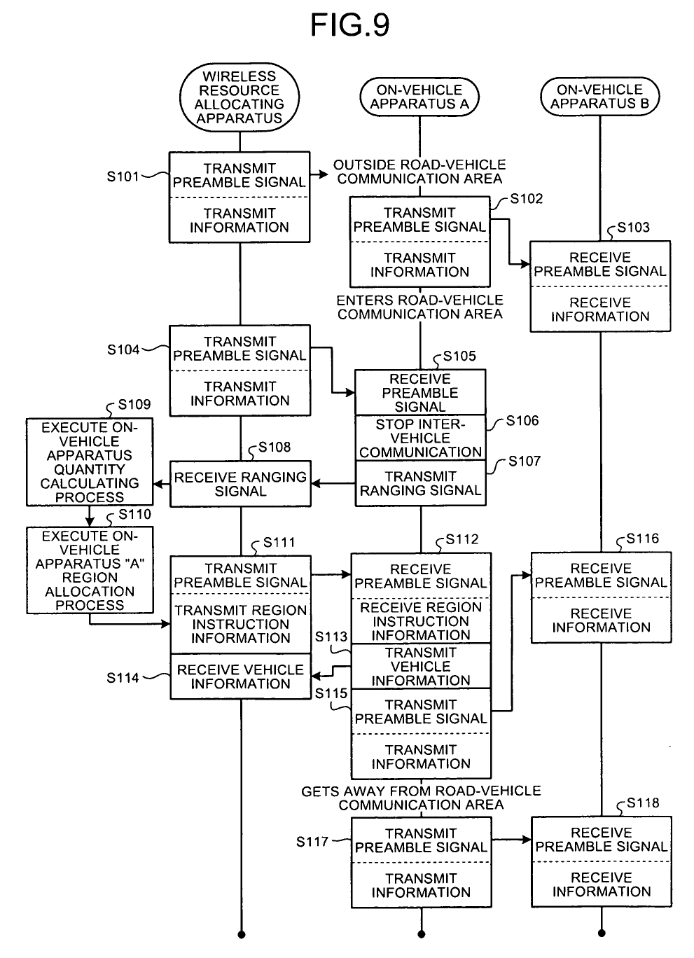

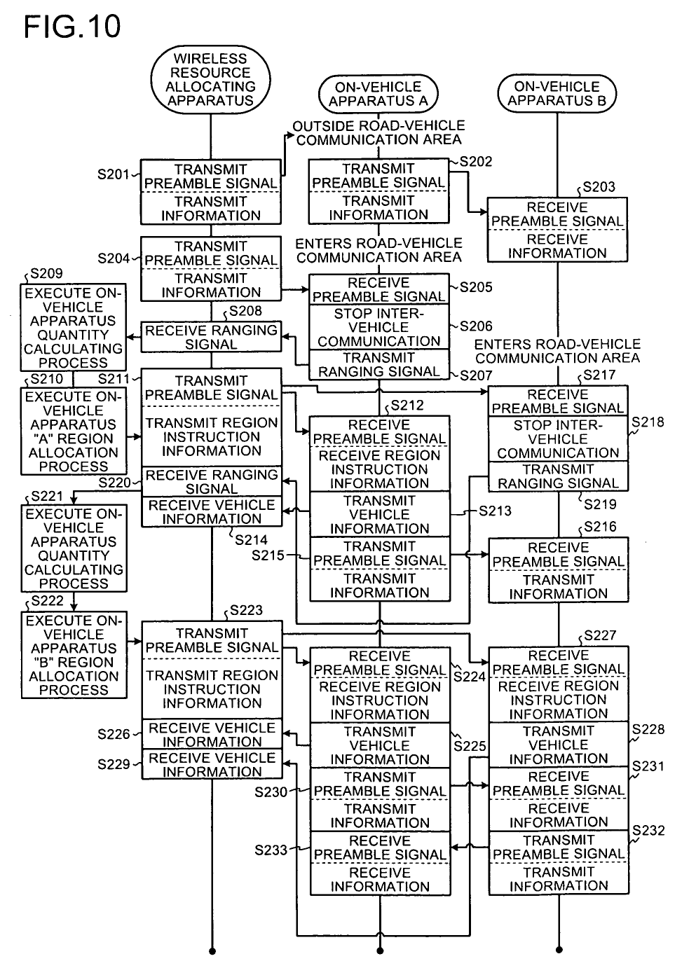

The overview of processes by the wireless resource allocating system according to the embodiment will be described referring to FIGS. 9 and 10. FIG. 9 is a sequence diagram of the overview of the processes of the wireless resource allocating system executed when an on-vehicle apparatus “A” approaches the road-vehicle communication area. Concerning FIGS. 9 and 10, the wireless resource allocating apparatus 100 executes the allocation of the wireless resources to be used for the road-vehicle communication and the inter-vehicle communication by distributing the plurality of timeslots in the frame.

The preamble signal transmitting unit 121 of the wireless resource allocating apparatus 100 transmits the preamble signal superposing the signal at the head of a frame (S101). However, when the on-vehicle apparatus A200-1 is outside the road-vehicle communication area, the on-vehicle apparatus A200-1 is not able to receive the preamble signal that the wireless resource allocating apparatus 100 transmits. In this case, to execute the autonomous inter-vehicle communication with the other on-vehicle apparatus B200-2, the on-vehicle apparatus A200-1, for example, transmits a preamble signal that includes congestion information (S102). The on-vehicle apparatus B200-2 receives the preamble signal together with, for example, information on the traffic around the on-vehicle apparatus A200-1 (S103) and executes the autonomous inter-vehicle communication with the on-vehicle apparatus B200-2.

Thereafter, the preamble signal transmitting unit 121 of the wireless resource allocating apparatus 100 transmits the preamble signal superposing the preamble signal at the head of a frame (S104).

In this case, the on-vehicle apparatus A200-1 that enters the road-vehicle communication area receives the preamble signal transmitted by the wireless resource allocating apparatus 100 using the preamble signal receiving unit 261 (S105). After the synchronization establishing unit 271 establishes synchronization, the on-vehicle apparatus A200-1 stops the autonomous inter-vehicle communication with the on-vehicle apparatus B200-2, using the inter-vehicle communication stopping unit 233 (S106). Simultaneously, the ranging signal transmitting unit 262 transmits the ranging signal to the wireless resource allocating apparatus 100 (S107).

The ranging signal receiving unit 122 of the wireless resource allocating apparatus 100 receives the ranging signal (S108).

When the ranging signal receiving unit 122 receives the ranging signal, the on-vehicle apparatus quantity calculating unit 131 of the wireless resource allocating apparatus 100 calculates the number of on-vehicle apparatuses currently present within the road-vehicle communication area (S109). For example, the on-vehicle apparatus quantity calculating unit 131 sums up the numbers of ranging signals received within the predetermined time period until the present.

The wireless resource allocating unit 134 of the wireless resource allocating apparatus 100 executes a region allocation process of allocating the wireless resources to the road-vehicle region and the inter-vehicle region, to the on-vehicle apparatus A200-1 based on the number of on-vehicle apparatuses calculated by the on-vehicle apparatus quantity calculating unit 131 (S110).

The allocation instruction transmitting unit 123 of the wireless resource allocating apparatus 100 transmits instruction information that instruct to use the wireless resources allocated by the region allocating process of the wireless resource allocating unit 134, together with the preamble signal, to the on-vehicle apparatus A200-1 (S111).

The allocation instruction receiving unit 263 of the on-vehicle apparatus A200-1 receives the instruction information transmitted by the wireless resource allocating apparatus 100 (S112). The PHY processing unit 260 transmits to the wireless resource allocation apparatus 100 vehicle information on the on-vehicle apparatus A200-1 using the road-vehicle region and according to the instruction information received by the allocation instruction receiving unit 263 (S113). In this case, the on-vehicle apparatus A200-1 executes road-vehicle communication using the road-vehicle region and, therefore, the inter-vehicle communication between the on-vehicle apparatuses A200-1 and B200-2 is stopped and the on-vehicle apparatus A200-1 is not able to communicate with the on-vehicle apparatus B200-2.

The PHY processing unit 120 of the wireless resource allocating apparatus 100 receives the vehicle information transmitted by the on-vehicle apparatus A200-1 (S114).

On the other hand, the PHY processing unit 300 of the on-vehicle apparatus A200-1 transmits to the on-vehicle apparatus B200-2, for example, information on the traffic around the on-vehicle apparatus A200-1 together with the preamble signal, using the inter-vehicle region and according to the instruction information of the wireless resources received by the allocation instruction receiving unit 263 (S115). In this case, the wireless resources are in the inter-vehicle region and the road-vehicle communication between the wireless resource allocating apparatus 100 and the on-vehicle apparatus A200-1 is stopped and, therefore, the wireless resource allocating apparatus 100 is not able to communicate with the on-vehicle apparatus A200-1.

The PHY processing unit 300 of the on-vehicle apparatus B200-2 receives the traffic information together with the preamble signal transmitted by the on-vehicle apparatus A200-1 (S116).

Thereafter, when the on-vehicle apparatus A200-1 gets away from the road-vehicle communication area, the on-vehicle apparatus A200-1 transmits, for example, information on the traffic around the on-vehicle apparatus A200-1 together with the preamble signal (S117). The on-vehicle apparatus B200-2 receives the traffic information together with the preamble signal transmitted by the on-vehicle apparatus S200-1 (S118) and executes autonomous inter-vehicle communication with the on-vehicle apparatus A200-1.

FIG. 10 is a sequence diagram of the overview of processes of the wireless resource allocating system executed when the on-vehicle apparatuses A and B enter the road-vehicle communication area. The overview of processes for the on-vehicle apparatus A200-1 to execute road-vehicle communication with the wireless resource allocating apparatus 100 and inter-vehicle communication with the on-vehicle apparatus B200-2 (S201 to S216) are same as the overview of the processes of FIG. 9 (S101 to S116) and description therefor is omitted.

The on-vehicle apparatus A200-1 receives the instruction information instructing to use the wireless resources to which the inter-vehicle region and the road-vehicle region are allocated by the wireless resource allocating apparatus 100 (S212), executes the road-vehicle communication according to the instruction information (S213), and executes inter-vehicle communication (S215).

When the on-vehicle apparatus B200-2 enters the road-vehicle communication area, the preamble signal receiving unit 261 of the on-vehicle apparatus B200-2 receives the preamble signal transmitted by the wireless resource allocating apparatus 100 (S217). After the synchronization establishing unit 271 establishes synchronization, the on-vehicle apparatus B200-2 stops the autonomous inter-vehicle communication with another on-vehicle apparatus using the inter-vehicle communication stopping unit 233 (S218). Simultaneously, the ranging signal transmitting unit 262 transmits the ranging signal to the wireless resource allocating apparatus 100 (S219).

The ranging signal receiving unit 122 of the wireless resource allocating apparatus 100 receives the ranging signal (S220).

When the ranging signal receiving unit 122 receives the ranging signal, the on-vehicle apparatus quantity calculating unit 131 of the wireless resource allocating apparatus 100 calculates the number of on-vehicle apparatuses currently present within the road-vehicle communication area (S221). For example, the on-vehicle apparatus quantity calculating unit 131 sums up the numbers of ranging signals received within the predetermined time period until the present.

The wireless resource allocating unit 134 of the wireless resource allocating apparatus 100 executes a region allocation process of allocating the wireless resources to the road-vehicle region and the inter-vehicle region, to the on-vehicle apparatuses A200-1 and B200-2 based on the number of on-vehicle apparatuses calculated by the on-vehicle apparatus quantity calculating unit 131 (S222). For example, based on the number of on-vehicle apparatuses, the wireless resource allocating unit 134 allocates the road-vehicle region and the inter-vehicle region and, for each region, allocates regions for the on-vehicle apparatuses A200-1 and B200-2 to use.

The allocation instruction transmitting unit 123 of the wireless resource allocating apparatus 100 transmits instruction information that instruct to use the wireless resources allocated to the road-vehicle region and the inter-vehicle region by the region allocating process of the monitor control unit 130, together with the preamble signal, to the on-vehicle apparatuses A200-1 and B200-2 (S223).

The allocation instruction receiving unit 263 of each of the on-vehicle apparatuses A200-1 and B200-2 receives the instruction information transmitted by the wireless resource allocating apparatus 100 (S224, S227).

The PHY processing unit 260 of each of the on-vehicle apparatuses A200-1 and B200-2 transmits to the wireless resource allocation apparatus 100 vehicle information on the on-vehicle apparatus using the road-vehicle region of the apparatus and according to the instruction information received by the allocation instruction receiving unit 263 (S225 and S228). In this case, the on-vehicle apparatuses A200-1 and B200-2 execute road-vehicle communication using the road-vehicle region and, therefore, the inter-vehicle communication between the on-vehicle apparatuses A200-1 and B200-2 is stopped and the on-vehicle apparatuses A200-1 and B200-2 are not able to execute the inter-vehicle communication.

The PHY processing unit 120 of the wireless resource allocating apparatus 100 receives the pieces of vehicle information transmitted by the on-vehicle apparatuses A200-1 and B200-2 (S226 and S229).

On the other hand, the PHY processing unit 300 of the on-vehicle apparatus A200-1 transmits to the on-vehicle apparatus B200-2, for example, information on the traffic around the on-vehicle apparatus A200-1 together with the preamble signal, using the inter-vehicle region of the on-vehicle apparatus A200-1 and according to the instruction information of the wireless resources received by the allocation instruction receiving unit 263 (S230). The PHY processing unit 300 of the on-vehicle apparatus B200-2 receives the traffic information transmitted by the on-vehicle apparatus A200-1 (S231). The PHY processing unit 300 of the on-vehicle apparatus B200-2 transmits to the on-vehicle apparatus A200-1, for example, information on the traffic around the on-vehicle apparatus B200-2 together with the preamble signal, using the inter-vehicle region of the on-vehicle apparatus B200-2 and according to the instruction information of the wireless resources received by the allocation instruction receiving unit 263 (S232). The PHY processing unit 300 of the on-vehicle apparatus A200-1 receives the traffic information transmitted by the on-vehicle apparatus B200-2 (S233). In this case, the wireless resources are in the inter-vehicle region and the road-vehicle communication between the wireless resource allocating apparatus 100 and the on-vehicle apparatuses A200-1 and B200-2 is stopped and, therefore, the wireless resource allocating apparatus 100 is not able to communicate with the on-vehicle apparatuses A200-1 and B200-2.

As above, according to the embodiment, the wireless resource allocating apparatus 100: receives a signal indicating that the on-vehicle apparatus 200 is present within the road-vehicle communication area with which the wireless resource allocating apparatus 100 is able to communicate; calculates the number of on-vehicle apparatuses present within the road-vehicle communication area from the signal received; allocates the wireless resources to be used for the inter-vehicle communication among a plurality of on-vehicle apparatuses and the road-vehicle communication between on-vehicle apparatuses and the wireless resource allocating apparatus 100 other than the on-vehicle apparatuses in the road-vehicle communication area based on the number of on-vehicle apparatuses calculated; and instructs the on-vehicle apparatus 200 present within the road-vehicle communication area to use the allocated wireless resources.

In this manner, the wireless resource allocating apparatus 100 allocates the wireless resources to be used for the inter-vehicle communication and the road-vehicle communication based on the number of the on-vehicle apparatuses 200 present within the road-vehicle communication area. Therefore, in the case where the number of on-vehicle apparatuses present within a predetermined area is large, when allocation of the wireless resources to be used for the inter-vehicle communication is increased, each on-vehicle apparatus is able to securely execute the inter-vehicle communication using the wireless resources and, in the case where the number of on-vehicle apparatuses is small, when the allocation of the wireless resources to be used for the inter-vehicle communication is reduced, wasteful allocation of the wireless resources to the inter-vehicle communication is able to be prevented and, therefore, the efficiency of use of the wireless resources for the inter-vehicle communication and the road-vehicle communication is able to be improved. Because the wireless resource allocating apparatus 100 allocates the wireless resources to be used for the inter-vehicle communication and the road-vehicle communication within the road-vehicle communication area, the inter-vehicle communication and the road-vehicle communication are executed each using different wireless resources within the road-vehicle communication area and, therefore, interference between the inter-vehicle communication and the road-vehicle communication is able to be prevented.

An arbitrary part of or the whole of each processing function executed in the wireless resource allocating apparatus and the on-vehicle apparatuses may be realized in a program analyzed and executed by a CPU (central processing unit) or may be realized as hardware by wired logics.

A wireless resource allocating apparatus, an on-vehicle apparatus, a wireless resource allocating system, and a wireless resource allocating method disclosed herein exert an effect that the efficiency of use of the wireless resources that are allocated to communication among on-vehicle apparatuses and communication between on-vehicle apparatuses and communicating apparatuses other than the on-vehicle apparatuses are enabled to be improved.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A wireless resource allocating apparatus comprising:
a receiving unit that receives a signal that indicates that an on-vehicle apparatus loaded on a vehicle is present within a predetermined area;
a calculating unit that calculates the number of the on-vehicle apparatuses present within the predetermined area from the signal received by the receiving unit;
an allocating unit that allocates wireless resources to be used for inter-vehicle communication between the on-vehicle apparatuses present within the predetermined area and non-inter-vehicle communication between the on-vehicle apparatus and a communicating apparatus other than the on-vehicle apparatus based on the number of the on-vehicle apparatuses calculated by the calculating unit; and
an instructing unit that instructs the on-vehicle apparatus present within the predetermined area to use the wireless resources allocated by the allocating unit.

2. The wireless resource allocating apparatus according to claim 1, wherein
the allocating unit allocates the wireless resources only to the non-inter-vehicle communication when the number of the on-vehicle apparatuses present within the predetermined area is zero or one.

3. The wireless resource allocating apparatus according to claim 1, wherein
the allocating unit allocates the wireless resources to only the non-inter-vehicle communication when the number of the on-vehicle apparatuses present within the predetermined area is equal to or larger than a predetermined number that indicates the saturated state of the on-vehicle apparatuses present in the predetermined area.

4. The wireless resources allocating apparatus according to claim 1, wherein
the allocating unit allocates the wireless resources by distributing a plurality of time slots in a frame that indicates a communication unit time period to the inter-vehicle communication and the non-inter-vehicle communication based on the number of the on-vehicle apparatuses calculated by the calculating unit.

5. The wireless resources allocating apparatus according to claim 1, wherein
the allocating unit allocates the wireless resources by distributing a plurality of frames in frames that indicate a communication unit time period to the inter-vehicle communication and the non-inter-vehicle communication based on the number of the on-vehicle apparatuses calculated by the calculating unit.

6. The wireless resource allocating apparatus according to claim 1, wherein
the allocating unit allocates a frequency band that is useable in the predetermined area to the inter-vehicle communication and the non-inter-vehicle communication by dividing the frequency band for the inter-vehicle communication and the non-inter-vehicle communication based on the number of the on-vehicle apparatuses calculated by the calculating unit.

7. The wireless resource allocating apparatus according to claim 1, wherein
the allocating unit allocates a frequency band that is usable within the predetermined area to a plurality of combinations obtained by selecting at least one of the inter-vehicle communication and the non-inter-vehicle communication by dividing the frequency band for the combinations, and further allocates a plurality of time slots in a frame based on the number of the on-vehicle apparatuses calculated by the calculating unit to communication of the combinations by distributing the time slots to the communication of the combinations.

8. An on-vehicle apparatus comprising:
a receiving unit that receives an instruction of allocation of wireless resources to be used for execution of inter-vehicle communication between on-vehicle apparatuses each loaded on a vehicle present within a predetermined area and non-inter-vehicle communication between the on-vehicle apparatuses and a communicating apparatus other than the on-vehicle apparatuses; and
a communicating unit that, according to the instruction received by the receiving unit, executes the inter-vehicle communication using the wireless resources allocated to the inter-vehicle communication and that executes the non-inter-vehicle communication using the wireless resources allocated to the non-inter-vehicle communication.

9. A wireless resource allocating system comprising an on-vehicle apparatus loaded on a vehicle and a wireless resource allocating apparatus, wherein
the wireless resource allocating apparatus comprises:
a receiving unit that receives a signal that indicates that the on-vehicle apparatuses is present within a predetermined area;
a calculating unit that calculates the number of the on-vehicle apparatuses present within the predetermined area from the signal received by the receiving unit;
an allocating unit that allocates wireless resources to be used for inter-vehicle communication between the on-vehicle apparatuses present within the predetermined area and non-inter-vehicle communication between the on-vehicle apparatuses and a communicating apparatus other than the on-vehicle apparatuses based on the number of the on-vehicle apparatuses calculated by the calculating unit; and
an instructing unit that instructs the on-vehicle apparatus present within the predetermined area to use the wireless resources allocated by the allocating unit, and wherein
the on-vehicle apparatus comprises:
a receiving unit that receives an instruction of allocation of wireless resources to be used for the inter-vehicle communication and the non-inter-vehicle communication instructed by the instructing unit; and
a communicating unit that, according to the instruction received by the receiving unit, executes the inter-vehicle communication using the wireless resources allocated to the inter-vehicle communication and that executes the non-inter-vehicle communication using the wireless resources allocated to the non-inter-vehicle communication.

10. A wireless resource allocating method comprising:
receiving a signal that indicates that an on-vehicle apparatus loaded on a vehicle is present within a predetermined area;
calculating the number of the on-vehicle apparatuses present within the predetermined area from the received signal;
allocating wireless resources to be used for inter-vehicle communication between the on-vehicle apparatuses present within the predetermined area and non-inter-vehicle communication between the on-vehicle apparatus and a communicating apparatus other than the on-vehicle apparatus based on the calculated number of the on-vehicle apparatuses; and
instructing the on-vehicle apparatus present within the predetermined area to use the allocated wireless resources.
